(19) United States
(12) Patent Application Publication
(10) Pub. No.: US 2007/0030532 A1
(43) Pub. Date: Feb. 8, 2007

(54) Apparatus for image forming of contributing to an effective utilization of a space therein

(75) Inventors: Tetsuya Fujioka, Kanagawa (JP); Takuji Takahashi, Kanagawa (JP); Yasunobu Youda, Kanagawa (JP); Hideto Higaki, Kanagawa (JP); Naohiro Yasuda, Kanagawa (JP); Toshiaki Kumashiro, Kanagawa (JP); Takashi Komatsu, Kanagawa (JP)

Correspondence Address: HARNESS, DICKEY & PIERCE, P.L.C., P.O. BOX 8910, RESTON, VA, 20195, US

(73) Assignee: Ricoh Co. Ltd.

(21) Appl. No.: 11/498,150

(22) Filed: Aug. 3, 2006

(30) Foreign Application Priority Data
Aug. 3, 2005 (JP) JP 2005-225866

(51) Int. Cl. H04N 1/04

(52) U.S. Cl. 358/474

(57) ABSTRACT

An image reading apparatus includes a housing having a bottom plate, a photoelectric conversion element configured to convert an optical signal of light reflected by an original document to an electrical signal, and a circuit board configured to implement a circuit controlling the signal sent from the photoelectric conversion element, wherein the bottom plate of the housing forms a portion thereof facing a lower end portion of the circuit board to protrude outwardly toward a downward direction of the bottom plate of the housing so that the lower end portion of the circuit board is accommodated therein or wherein the bottom plate of the housing includes an opening portion facing the lower end portion of the circuit board so that the lower end portion of the circuit board is protruded from the opening portion in a downward direction of the bottom plate of the housing.

### CROSS REFERENCE TO RELATED APPLICATIONS

The present patent application claims priority under 35 U.S.C. §199 upon Japanese patent application no. 2005-225866, filed in the Japan Patent Office on Aug. 3, 2005, the disclosure of which is incorporated by reference herein in its entirety.

### BACKGROUND

1. Field

The present patent application generally relates to an apparatus for image forming. For example, at least one embodiment of the present patent application relates to an image forming apparatus, for example, a copier, printer, facsimile machine and/or multifunctional machine having at least two functions of copier, printer, facsimile machine and so forth, the image forming apparatus of contributing to an effective utilization of a space therein, and an image reading device used in the image forming apparatus.

2. Discussion of the Related Art

Background image reading devices includes a circuit board that controls respective electrical input and output signals of photoelectric conversion elements so as to electrically connects the circuit board and the photoelectric conversion elements by a flexible connecting members.

Such background image reading device is generally used in combination with an image forming device for use in a background image forming apparatus.

Such image forming apparatus, however, is required to reduce its size according to strong demands for saving installation space for the image forming apparatus.

### SUMMARY

One of more embodiments of the present patent application has been made, taking the above-mentioned circumstances into consideration.

At least one embodiment of the present patent application provides an image reading device that includes a housing having a bottom plate, a photoelectric conversion element configured to convert an optical signal of light reflected by an original document to an electrical signal, and a circuit board configured to implement a circuit controlling the signal sent from the photoelectric conversion element, wherein the bottom plate of the housing forms a portion thereof facing a lower end portion of the circuit board to protrude outwardly toward a downward direction of the bottom plate of the housing so that the lower end portion of the circuit board is accommodated therein.

At least one embodiment of the present patent application provides an image reading device that includes a housing having a bottom plate, a photoelectric conversion element configured to convert an optical signal of light reflected by an original document to an electrical signal, and a circuit board configured to implement a circuit controlling the signal sent from the photoelectric conversion element, wherein the bottom plate of the housing includes an opening portion facing a lower end portion of the circuit board so that the lower end portion of the circuit board is protruded from the opening portion in a downward direction of the bottom plate of the housing.

At least one embodiment of the present patent application provides an image forming apparatus that includes an image forming device configured to form an image, and an image reading device including a housing having a bottom plate, a photoelectric conversion element configured to convert an optical signal of light reflected by an original document to an electrical signal, and a circuit board configured to implement a circuit controlling the signal sent from the photoelectric conversion element, wherein the bottom plate of the housing forms a portion thereof facing a lower end portion of the circuit board to depress outwardly toward a downward direction of the bottom plate of the housing so that the lower end portion of the circuit board is accommodated therein.

At least one embodiment of the present patent application provides an image forming apparatus that includes an image forming device configured to forming an image, and an image reading device including a housing having a bottom plate, a photoelectric conversion element configured to convert an optical signal of light reflected by an original document to an electrical signal, and a circuit board configured to implement a circuit controlling the signal sent from the photoelectric conversion element, wherein the bottom plate of the housing includes an opening portion facing a lower end portion of the circuit board so that the lower end portion of the circuit board is protruded from the opening portion in a downward direction of the bottom plate of the housing.

At least one embodiment of the present patent application provides an image reading device capable of having a sheet traveling space therebelow for receiving a printed medium, including a photoelectric conversion element configured to convert an optical signal of light reflected by an original document to an electrical signal, a circuit board configured to implement a circuit controlling the signal sent from the photoelectric conversion element, and a housing including a base member configured to retain the photoelectric conversion element and the circuit board thereon in one of direct and indirect manner, wherein the housing further including a retaining surface configured to retain the base member and wherein a lower end portion of the circuit board is placed lower than the retaining surface of the housing and is arranged out of the sheet traveling space.

At least one embodiment of the present patent application provides an image forming apparatus that includes an image forming device configured to form an image and including a sheet traveling space configured to receive a recording medium having the image thereon, and an image reading device including a photoelectric conversion element configured to convert an optical signal of light reflected by an original document to an electrical signal, a circuit board configured to implement a circuit controlling the signal sent from the photoelectric conversion element, and a housing including a base member configured to retain the photoelectric conversion element and the circuit board thereon in one of direct and indirect manner, wherein the housing further including a retaining surface configured to retain the base member and wherein a lower end portion of the circuit board is placed lower than the retaining surface of the housing and is arranged out of the sheet traveling space.

### BRIEF DESCRIPTION OF THE DRAWINGS

The accompanying drawings are intended to depict example embodiments of the present invention and should not be interpreted to limit the scope thereof. The accompanying drawings are not to be considered as drawn to scale unless explicitly noted.

A more complete appreciation of the disclosure and many of the attendant advantages thereof will be readily obtained as the same becomes better understood by reference to the following detailed description when considered in connection with the accompanying drawings, wherein:

FIG. 1 is a schematic structure of an image forming apparatus as at least one example embodiment of the present patent application;

FIG. 2 is a cross sectional view showing an overall structure of an optical scanning device according to the at least one example embodiment of the present patent application;

FIG. 3 is a perspective view of a lens block according to the at least one example embodiment of the present patent application;

FIG. 4 is a side elevation view of the lens block according to a first example embodiment of the present patent application; and

FIG. 5 is a side elevation view of the lens block according to a second example embodiment of the present patent application.

### DETAILED DESCRIPTION OF THE EXAMPLE EMBODIMENTS

It will be understood that if an element or layer is referred to as being “on”, “against”, “connected to” or “coupled to” another element or layer, then it can be directly on, against, connected or coupled to the other element or layer, or intervening elements or layers may be present. In contrast, if an element is referred to as being “directly on”, “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath”, “below”, “lower”, “above”, “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would hen be oriented “above” the other elements or features. Thus, term such as “below” can encompass both an orientation of above and below. The device may be otherwise oriented (rotated 90 degrees or at other orientations) and the spatially relative descriptors herein interpreted accordingly.

Although the terms first, second, etc. may be used herein to described various elements, components, regions, layers and/or sections, it should be understood that these elements, components, regions, layer and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, example embodiments of the present patent application are described.

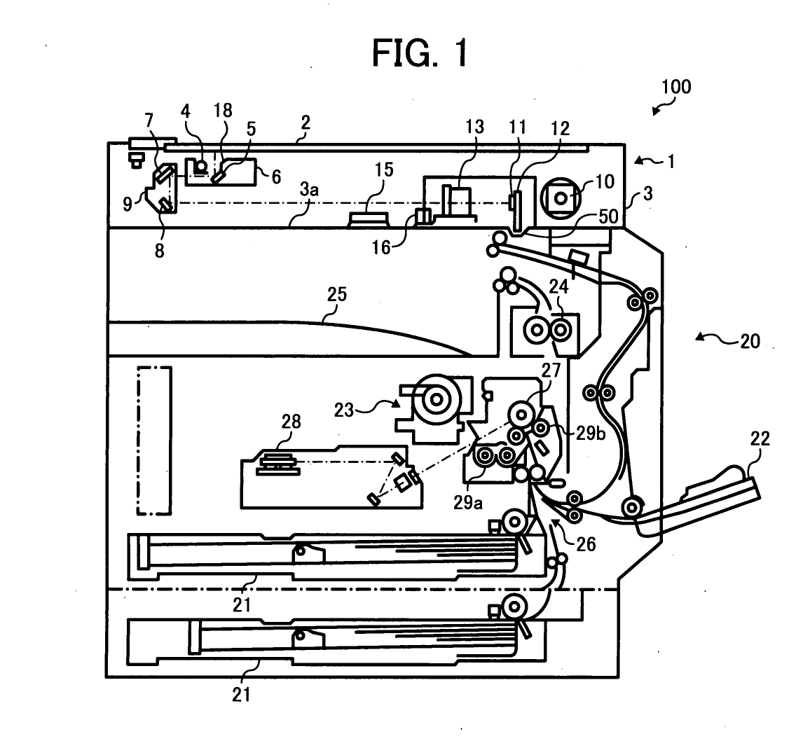

Referring to FIG. 1, a schematic structure of an image forming apparatus 100 as at least one example embodiment of the present patent application is described.

FIG. 1 is a cross sectional view of the image forming apparatus 100 serving as a copier.

The image forming apparatus 100 includes an optical scanning device 1 and a printing device 20.

The optical scanning device 1 is a flatbed scanner type image reading device and is disposed at an upper part of the image forming apparatus 100.

The printing device 20 is an image forming device that forms an image on an original document scanned and read by the optical scanning device 1 on a recording medium. The printing device 20 includes sheet feeding trays 21, a manual sheet feeding tray 22, an electrophotographic printer engine 23, a fixing unit 24, a sheet discharging stacker section 25, and a sheet conveying path 26.

In the printing device 20, a recording medium having a sheet-like form or a recording sheet is fed from one of the sheet feeding trays 21 that accommodate a stack of recording sheets therein or from the manual sheet feeding tray 22 that manually feeds the recording sheets to the electrophotographic printer engine 23. The recording sheet is further conveyed, via the fixing unit 24 through the sheet conveying path 26, to the sheet discharging stacker section 25.

The electrophotographic printer engine 23 includes a photoconductive element 27, and a charging unit (not shown), an optical writing unit 28, a developing unit 29a, and a transfer unit 29b arranged around the photoconductive element 27.

When the image data of an image on an original document scanned and read by the optical scanning device 1 is sent to the printing device 20 performing an electrophotographic image forming operation, the optical writing unit 28 converts the image data into optical signals.

The charging unit uniformly charges the surface of the photoconductive element 27 that serves as an image bearing member.

The optical writing unit 28 then emits a laser light beam and irradiates a surface of the photoconductive element 27 to form an electrostatic latent image.

The developing unit 29a develops the electrostatic latent image formed on the surface of the photoconductive element 27 with toner into a toner image.

The toner image on the photoconductive element 27 is transferred onto a recording sheet fed from one of the sheet feeding trays 21 or the manual sheet feeding tray 22.

Subsequently, the fixing unit 24 fixes the toner image transferred onto the recording sheet thereto.

The recording sheet having the fixed toner image is then discharged to the sheet discharging stacker section 25.

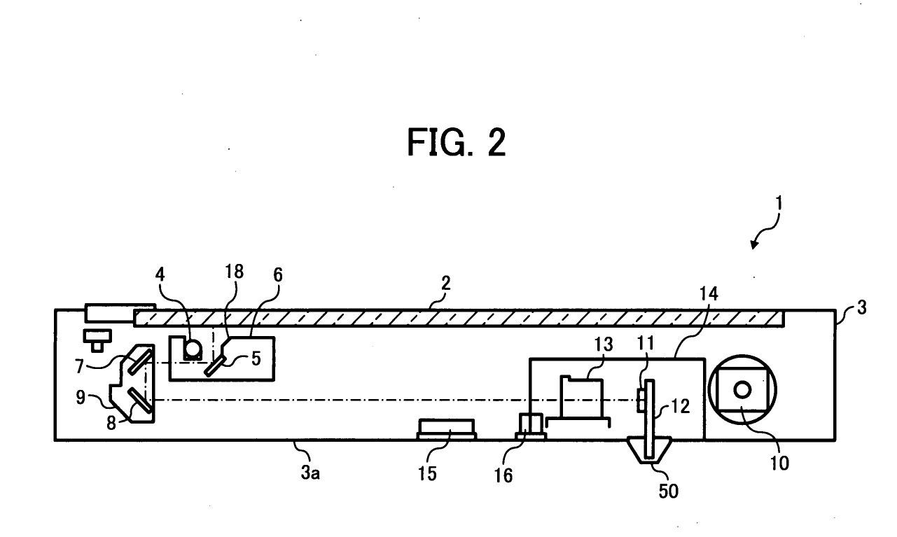

Referring to FIG. 2, a schematic structure of the optical scanning device 1 is described.

FIG. 2 is a cross sectional view showing an overall structure of the optical scanning device 1.

The optical scanning device 1 includes a contact glass 2 and a housing 3.

The contact glass 2 is disposed at the upper surface of the housing 3 for setting or placing original documents thereon.

The housing 3 has a case-like shape and accommodates image reading components therein. More particularly the housing 3 includes a xenon lamp 4, a first mirror 5, a first moving carriage 6, a second mirror 7, a third mirror 8, and a second moving carriage 9.

The xenon lamp 4 is carried by the first moving carriage 6 and serves as a light source that irradiates an image surface of an original document set on the contact glass 2 with light. Hereinafter, the xenon lamp 4 is referred to as a “Xe lamp.”

The first mirror 5 is also carried by the first moving carriage 6 and is inclined at approximately 45 degrees to reflect the light reflected from the image surface of the original document.

The second and third mirrors 7 and 8 are carried by the second moving carriage 9 and are respectively inclined at approximately 45 degrees to reflect the light reflected by the first mirror 5. The second and third mirrors 7 and 8 disposed described above respectively deflect the light to the direction perpendicular to the direction of incident light when received by the respective mirrors 7 and 8. As a result, the direction of an optical axis of the light reflected by the first mirror 5 may be deflected by 180 degrees.

The Xe lamp 4 irradiates the image surface of the original document set or placed on the contact glass 2 in a linear manner in a longitudinal direction thereof. By the reflection of the light reflected from the image surface of the original document, an image pickup device scans and reads the irradiated area. The linearly area irradiated in the longitudinal direction of the Xe lamp 4 is equal to the main scanning direction of the image surface of the original document.

The first and second moving carriages 6 and 9 are arranged such that each longitudinal direction thereof corresponds to the main scanning direction, i.e., in a direction perpendicular to the sheet in FIG. 2. The first and second moving carriages 6 and 9 reciprocate in a sub-scanning direction, i.e., in a right-and-left direction in FIG. 2, at a speed ratio of two to one.

The first and second moving carriages 6 and 9 during its standby mode for scanning an image of an original document are located at their respective home positions at the left-hand side of the housing 3 of FIG. 2.

The Xe lamp 4 and the first, second and third mirrors 5, 7 and 8 form an optical system for scanning along an image on an original document.

The Xe lamp 4 has a slit-like aperture along its axial direction at the position in which the Xe lamp 4 faces the contact glass 2. Further, a reflector 18 is attached to the Xe lamp 4 such that the light reflection direction of the reflector 18 corresponds to the axial direction of the Xe lamp 4 so as to cover the positions of the Xe lamp 4 other than the slit-like aperture. By use of the reflector 18, the light is efficiently emitted from the Xe lamp 4 toward an original document set on the contact glass 2.

The housing 3 further includes a drive motor 10, a sensor board unit or SBU 12, a lens block 13, and a lens block stay 14.

The drive motor 10 includes a stepping motor and drives the first and second moving carriages 6 and 9 to reciprocate in the sub-scanning direction.

The SBU 12 includes a three-line charge-coupled device or three-line CCD 11 thereon. The SBU 12 serves as a circuit board and implements or mounts a circuit controlling input and output signals sent from the three-line CCD 11.

The three-line CCD 11 includes a photoelectric transducer array having three lines and serves as a photoelectric conversion element that converts an optical signal into an electrical signal. The three-line CCD 11 is sometimes referred to as a line photoelectric transducer 11.

The lens block 13 is mounted on the lens block stay 14.

In addition, a sheet width sensor 15 and a sheet length sensor 16 are disposed on a bottom plate 3a of the housing 3. The sheet width sensor 15 and the sheet length sensor 16 detect a size of an original document set on the contact glass 2.

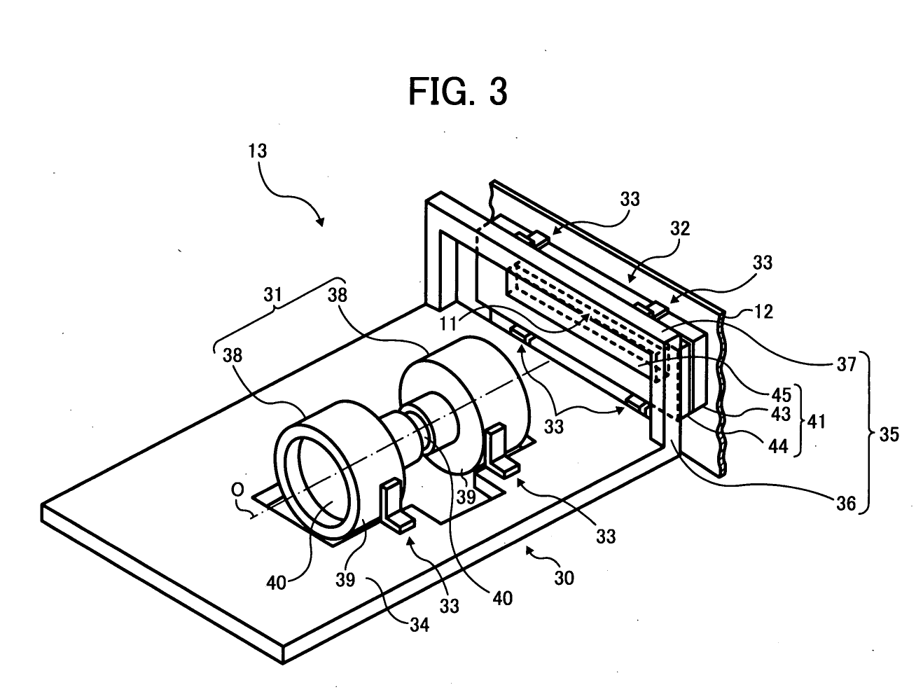

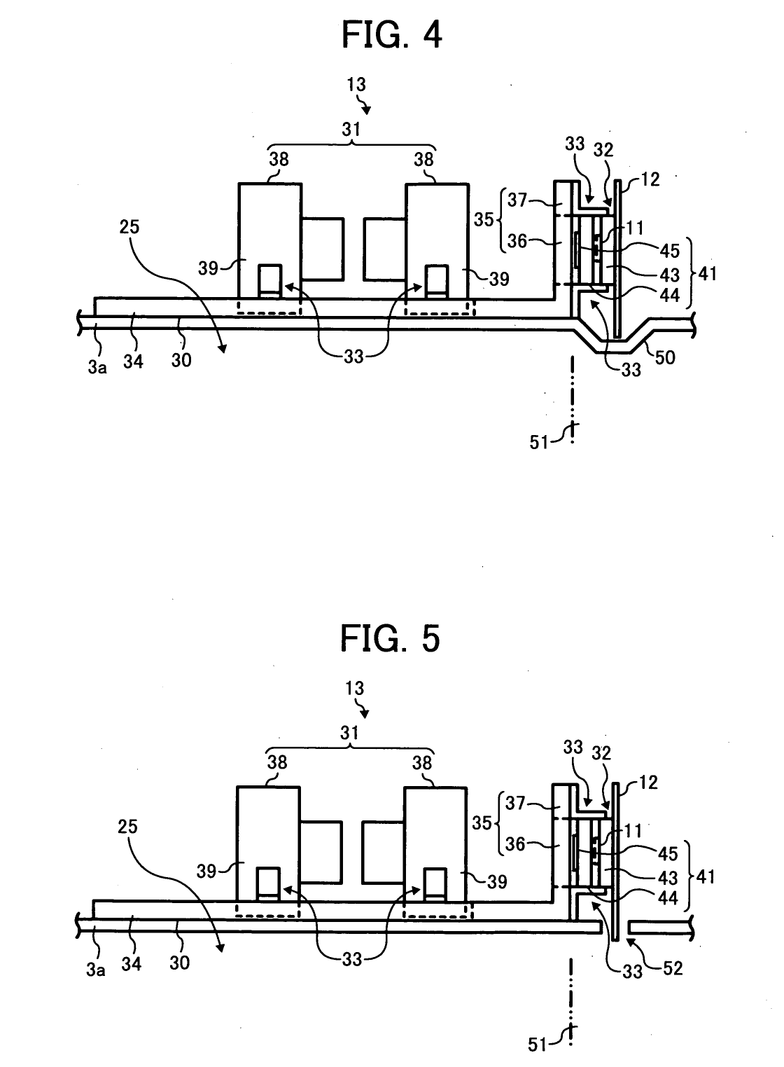

Referring to FIGS. 3 and 4, a structure of the lens block 13 is described.

FIG. 3 is a perspective view of the lens block 13, and FIG. 4 is a side elevation view of the lens block 13.

As shown in FIGS. 3 and 4, the lens block 13 includes a base member 30, an image forming lens system 31, an image sensor 32, and a plurality of intermediate retaining members 33.

The base member 30 includes a flat plate portion 34 and an upright portion 35.

The flat plate portion 34 includes a planar shape that is rectangular, and both surfaces of the flat plate portion 34 are arranged to be in parallel with a horizontal direction.

The upright portion 35 stands up from one end of the left and right directions of FIG. 4 of the flat plate portion 34. Specifically, the upright portion 35 stands up from one of the end portions in the longitudinal direction of the flat plate portion 34.

The upright portion 35 includes a pair of upright pillars 36 and a connecting pillar 37 and is formed in a frame-like shape.

The pair of upright pillars 36 stands from both end portions of a width direction of the flat plate portion 34.

The connecting pillar 37 connects mutual end portions of the pair of upright pillars 36 at a side distant from the flat plate portion 34.

The image forming lens system 31 serves as an optical element having a transparent surface thereon so that the reflected light or images of the original document can pass through the transparent surface of the image forming lens system 31. The image forming lens system 31 includes two optical units 38 that are separate bodies, mutually.

Each of the optical units 38 includes a lens cylinder 39 and a lens group 40 accommodated in the lens cylinder 39.

The lens cylinder 39 is formed in a tube-like or cylindrical shape.

At least one lens of the lens group 40 is press fit into the lens cylinder 39.

The lens cylinder 39, i.e., the optical units 38 is mounted on the flat plate portion 34 of the base member 30 via the plurality of intermediate retaining members 33.

The two optical units 38 are disposed in such a manner that the optical axes thereof are positioned collinearly to each other. The image forming lens system 31, which is structured as described above, forms images, according to the reflected light or images of the original document, on the line photoelectric transducer 11 of the image sensor 32.

The image sensor 32 includes a package 41 and the line photoelectric transducer 11 as the photoelectric conversion element.

The package 41 includes a base 43, a wind frame 44, and a sealing glass 45.

The base 43 and the wind frame 44 include, for example but not limited to, ceramics.

The base 43 is formed in a plate-like shape, and the line photoelectric transducer 11 is formed on a surface thereof.

The wind frame 44 is formed in a frame-like shape, and is fixed to the base 43 with an adhesive in such a manner as to overlap with an outer edge of the base 43.

The sealing glass 45 is formed in a plate-like shape, and an outer edge thereof is fixed to the wind frame 44 with the adhesive in such a manner as to coincide with the wind frame 44.

The package 41 covers the line photoelectric transducer 42 by the base 43, the wind frame 44, and the sealing glass 45. In addition, the package 41 is mounted to the SUB 12 serving as a printing wiring board, for example.

The line photoelectric transducer 11 is structured by, for example but not limited to, a PD (Photo Diode) as a photoelectric conversion element and a CCD (Charge-Coupled Device) as a charge-transport element that are arranged in the straight lines. A longitudinal direction of the line photoelectric transducer 11 is in parallel with the main scanning direction.

Hereinafter, the optical scanning device 1 serving as an image reading unit and the image forming apparatus 100 according to a first example embodiment of the present patent application is described with reference to FIGS. 1 and 4.

The optical scanning device 1 included in the image forming apparatus 100 according to the first example embodiment of the present patent application further includes a depressed portion 50 at the bottom plate 3a of the housing 3. The bottom plate 3a serves as a retaining surface for retaining the base member 30.

The depressed portion 50 may be arranged on the bottom plate 3a of the housing 3, in a given area or portion opposite to or facing the lower end portion of the SBU 12. The depressed portion 50 may be depressed or protruded outwardly from the bottom plate 3a toward the downward direction. The depressed portion 50 may also be formed in a downwardly tapered conical shape. With the depressed portion 50 on the bottom plate 3a, the lower end portion of the SBU 12 can be accommodated therein and the lower end portion of the SBU 12 can be placed lower than the level of the bottom plate 3a.

The depressed portion 50 may be arranged out of the sheet discharging stacker section 25, and more specifically may be arranged at an upper portion of a supporting pillar 51 that is disposed above the fixing unit 24 of the image forming apparatus 100 in FIG. 1 to support the housing 3. The supporting pillar 51 or other supporting pillars (not shown) may surround the depressed portion 50 so as to hide and conceal the depressed portion 50 and the lower end portion of the SBU 12 accommodated therein.

As described above, a space that corresponds to the lower portion of the housing 3 of the optical scanning device 1 and that is arranged out of the sheet discharging stacker section 25 as a sheet traveling space can effectively be utilized and can accommodate the lower end portion of the SBU 12 in the depressed portion 50 formed in the space. Thereby, the three-line CCD 11 serving as a photoelectric conversion element and other image reading components can be installed in a more flexible manner. Consequently, the image forming apparatus 100 in combination of the optical scanning device 1, the printing device 20 and so forth can reduce the entire size, especially in height, of the image forming apparatus.

Further, since the first and second moving carriages 6 and 9 are moved above the SBU 12 in the upper portion of the housing 3, the upper end portion of the SBU 12 may be limited or restricted for the installation of the SBU 12. However, by providing the depressed portion 50 at the bottom plate 3a, the lower end portion of the SBU 12 can be placed at a position lower than the bottom plate 3a, resulting in a contribution to a reduction of the entire size, especially in height, of the image forming apparatus 100.

Next, the lens block 13 of the optical scanning device 1 of the image forming apparatus 100 according to a second example embodiment of the present patent application is described with reference to FIG. 5.

In the second example embodiment of the present patent application, components same or equivalent to those described in the first example embodiment are attached with same reference numbers, and overlapping description will be omitted.

In the second example embodiment of the present patent application, the optical scanning device 1 includes an interspatial portion 52, instead of the depressed portion 50. The interspatial portion 52 may be arranged on the bottom plate 3a of the housing 3. More specifically, the interspatial portion 52 may be an opening portion formed in a given area or portion opposite to or facing the lower end portion of the SBU 12. The interspatial portion 52 can cause the lower end portion of the SBU 12 to protrude therefrom in a downward direction.

Similar to the first example embodiment of the present patent application, in the second example embodiment, the interspatial portion 52 formed such that the lower end portion of the SBU 12 protrudes therethrough. may be arranged out of the sheet discharging stacker section 25. With the above-described structure, the supporting pillar 51 or other supporting pillars (not shown) may surround the lower end portion of the SBU 12 protruding through the interspatial portion 52 so that the lower end portion of the SBU 12 can be hidden or concealed.

Alternatively to the interspatial portion 52, an opening or hole can be formed on the bottom plate 3a. The lower end portion of the SBU 12 can be exposed from the opening or hole in the downward direction.

Accordingly, in the second example embodiment similar to the first example embodiment, the space that corresponds to the lower portion of the housing 3 of the optical scanning device 1 and that is arranged out of the sheet discharging stacker section 25 as a sheet traveling space can effectively be utilized and can accommodate the lower end portion of the SBU 12 protruding from the interspatial portion 52 formed in the space. Thereby, the three-line CCD 11 and other image reading components can be installed in a more flexible manner. Consequently, the image forming apparatus 100 in combination of the optical scanning device 1, the printing device 20 and so forth can reduce the entire size of the image forming apparatus.

Further, similar to the first example embodiment, the movements of the first and second moving carriages 6 and 9 above the SBU 12 in the upper portion of the housing 3 may limit or restrict the installation of the SBU 12. However, by providing the interspatial portion 52 at the bottom plate 3a to cause the lower portion of the SBU 12 therethrough, the lower end portion of the SBU 12 can be placed at a position lower than the bottom plate 3a, resulting in a contribution to a reduction of the entire size, especially in height, of the image forming apparatus 100.

Although the invention has been described in its preferred form with a certain degree of particularity, it is to be noted that the present patent application is not limited to the embodiments described in the foregoing, and obviously many changes and variations are possible therein without departing from the scope and spirit of the invention.

For example, the present patent application is not limited to the flatbed scanner type image reading device 1 in which an original document is fixedly placed on the contact glass 2, but is also applicable to other type image reading devices.

Further, the present patent application is not limited to the copier type image forming apparatus 100 shown in the drawings, but is also applicable to other image forming apparatuses, such as different type copiers, printers, facsimile machines, or multifunctional machines including at least two functions of copier, printer, facsimile machine and so forth.

The above-described example embodiments are illustrative, and numerous additional modifications and variations are possible in light of the above teachings. For example, elements and/or features of different example embodiments herein may be combined with each other and/or substituted for each other within the scope of this disclosure and appended claims. It is therefore to be understood that within the scope of the appended claims, the disclosure of this patent specification may be practiced otherwise than as specifically described herein.

What is claimed:

1. An image reading device, comprising:
a housing having a bottom plate;
a photoelectric conversion element configured to convert an optical signal of light reflected by an original document to an electrical signal; and
a circuit board configured to implement a circuit controlling the signal sent from the photoelectric conversion element,
wherein the bottom plate of the housing forms a portion thereof facing a lower end portion of the circuit board to protrude outwardly toward a downward direction of the bottom plate of the housing so that the lower end portion of the circuit board is accommodated therein.

2. The image reading device according to claim 1, further comprising:
a light source configured to emit light with respect to the original document; and
an optical element having a transparent surface thereon and configured to cause the light reflected by the original document to pass through the transparent surface.

3. The image reading device according to claim 2, wherein:
when the image reading device is used in combination with an image forming device, the portion formed on the bottom plate of the housing is arranged out of a sheet traveling space of the image forming device.

4. The image reading device according to claim 1, further comprising:
a moving carriage configured to include the light source and disposed above the circuit board in an upper portion of the housing.

5. An image reading device, comprising:
a housing having a bottom plate;
a photoelectric conversion element configured to convert an optical signal of light reflected by an original document to an electrical signal; and
a circuit board configured to implement a circuit controlling the signal sent from the photoelectric conversion element,
wherein the bottom plate of the housing includes an opening portion facing a lower end portion of the circuit board so that the lower end portion of the circuit board is protruded from the opening portion in a downward direction of the bottom plate of the housing.

6. The image reading device according to claim 5, further comprising:
a light source configured to emit light with respect to the original document; and
an optical element having a transparent surface thereon and configured to cause the light reflected by the original document to pass through the transparent surface.

7. The image reading device according to claim 6, wherein:
when the image reading device is used in combination with an image forming device, the lower end portion of the circuit board protruding form the opening portion is arranged out of a sheet traveling space of the image forming device.

8. The image reading device according to claim 1, further comprising:
a moving carriage configured to include the light source and disposed above the circuit board in an upper portion of the housing.

9. An image forming apparatus, comprising:
an image forming device configured to form an image; and
an image reading device, comprising:
a housing having a bottom plate;
a photoelectric conversion element configured to convert an optical signal of light reflected by an original document to an electrical signal; and
a circuit board configured to implement a circuit controlling the signal sent from the photoelectric conversion element,
wherein the bottom plate of the housing forms a portion thereof facing a lower end portion of the circuit board to depress outwardly toward a downward direction of the bottom plate of the housing so that the lower end portion of the circuit board is accommodated therein.

10. An image forming apparatus, comprising:
an image forming device configured to forming an image; and
an image reading device, comprising:
a housing having a bottom plate;
a photoelectric conversion element configured to convert an optical signal of light reflected by an original document to an electrical signal; and
a circuit board configured to implement a circuit controlling the signal sent from the photoelectric conversion element,
wherein the bottom plate of the housing includes an opening portion facing a lower end portion of the circuit board so that the lower end portion of the circuit board is protruded from the opening portion in a downward direction of the bottom plate of the housing.

11. An image reading device capable of having a sheet traveling space therebelow for receiving a printed medium, comprising:
a photoelectric conversion element configured to convert an optical signal of light reflected by an original document to an electrical signal;
a circuit board configured to implement a circuit controlling the signal sent from the photoelectric conversion element; and
a housing including a base member configured to retain the photoelectric conversion element and the circuit board. thereon in one of direct and indirect manner,
wherein the housing further including a retaining surface configured to retain the base member, and
wherein a lower end portion of the circuit board is placed lower than the retaining surface of the housing and is arranged out of the sheet traveling space.

12. The image reading device according to claim 11, further comprising:
a moving carriage configured to include a light source configured to emit light with respect to the original document and disposed above the circuit board in an upper portion of the housing.

13. The image reading device according to claim 11, wherein:
the retaining surface of the housing forms a portion thereof facing the lower end portion of the circuit board to protrude outwardly toward a downward direction of the retaining surface of the housing so that the lower end portion of the circuit board is accommodated therein.

14. The image reading device according to claim 11, wherein:
the retaining surface of the housing forms a portion thereof facing the lower end portion of the circuit board to depress outwardly toward a downward direction of the retaining surface of the housing so that the lower end portion of the circuit board is accommodated therein.

15. The image reading device according to claim 14, wherein:
the portion is formed in a downwardly tapered conical shape.

16. The image reading device according to claim 11, wherein:
the retaining surface of the housing includes an opening portion facing the lower end portion of the circuit board so that the lower end portion of the circuit board is protruded from the opening portion in a downward direction of the retaining surface of the housing.

17. The image reading device according to claim 11, wherein:
the retaining surface of the housing includes a hole facing the lower end portion of the circuit board so that the lower end portion of the circuit board is exposed from the hole in a downward direction of the retaining surface of the housing.

18. An image forming apparatus, comprising:
an image forming device configured to form an image, the image forming device comprising a sheet traveling space configured to receive a recording medium having the image thereon; and
an image reading device, comprising:
a photoelectric conversion element configured to convert an optical signal of light reflected by an original document to an electrical signal;
a circuit board configured to implement a circuit controlling the signal sent from the photoelectric conversion element; and
a housing including a base member configured to retain the photoelectric conversion element and the circuit board thereon in one of direct and indirect manner,
wherein the housing further including a retaining surface configured to retain the base member, and
wherein a lower end portion of the circuit board is placed lower than the retaining surface of the housing and is arranged out of the sheet traveling space.

19. The image forming apparatus according to claim 18, further comprising:
at least one supporting pillar configured to support the housing and surround the lower end portion of the circuit board so that the lower end portion of the circuit board is concealed.
